(19) United States
(12) Patent Application Publication
(10) Pub. No.: US 2013/0300115 A1
(43) Pub. Date: Nov. 14, 2013

(54) SYSTEMS AND METHODS FOR OPTIMIZING POWER GENERATION IN A WIND FARM TURBINE ARRAY

(71) Applicants: John E. Seem, Glendale, WI (US); Yaoyu Li, Allen, TX (US)

(72) Inventors: John E. Seem, Glendale, WI (US); Yaoyu Li, Allen, TX (US)

(73) Assignee: Johnson Controls Technology Company

(21) Appl. No.: 13/466,891

(22) Filed: May 8, 2012

(51) Int. Cl. H02P 9/04

(52) U.S. Cl. 290/44

(57) ABSTRACT

A method for controlling turbines in a wind farm turbine array is shown and described. The method includes using a cascade of self-optimizing controllers to in an attempt to maximize the power generated by at least a portion of the wind farm turbine array, wherein at least one of the self-optimizing controllers for an upstream turbine is configured to control the upstream turbine in an attempt to maximize the combined total of (a) the power output of the upstream turbine and (b) the power output of at least one downstream turbine.

### BACKGROUND

The present invention relates generally to the field of electricity-producing wind farms.

Alternative energy sources, such as wind power, provide an attractive solution to today's growing demand for energy. Wind power is a readily available and renewable resource in many areas of the world. In addition, wind power is also a clean source of energy because the harvesting of wind power does not release chemical byproducts, such as greenhouse gasses, into the atmosphere.

Wind turbines are used to convert harvested wind energy into electricity. Wind power is used to turn the rotor of the turbine and the rotor drives a generator, which converts the captured mechanical energy into electricity. Modern turbines also include various controls for adjusting rotor speed, blade pitch, and orientation (e.g., rotor axis direction) relative to the direction of the wind.

Turbines are often positioned in relatively close geographic proximity of one another, in order to increase the amount of wind power harvested in a particularly windy area. Such wind farms are becoming more common. One challenge in the wind farms is that a downstream turbine that is in the wake of another turbine experiences different wind dynamics than that of the upstream turbine. Optimizing the power generation by a wind farm to account for downstream wind dynamics is challenging and difficult.

### SUMMARY

One embodiment of the invention relates to a method for controlling turbines in a wind farm turbine array. The method includes using a cascade of self-optimizing controllers to in an attempt to maximize the power generated by at least a portion of the wind farm turbine array. At least one of the self-optimizing controllers for an upstream turbine is configured to control the upstream turbine in an attempt to maximize the combined total of (a) the power output of the upstream turbine and (b) the power output of at least one downstream turbine. In some exemplary embodiments, the self-optimizing controllers are extremum seeking controllers.

Another embodiment relates to a control system for use with a wind farm turbine array. The control system includes a plurality of self-optimizing controllers, at least one self-optimizing controller for each turbine of the wind farm turbine array. At least one of the self-optimizing controllers is configured to seek an operating parameter that maximize the combined power generated by the controller's turbine and at least one turbine downstream from the controller's turbine. At least one of the self-optimizing controllers may be an extremum seeking controller. The operating parameter may be or include a pitch angle or rotor speed for the upstream turbine. Tip speed ratio (or torque or angular velocity) can be adopted in place of turbine rotor speed.

Yet another embodiment of the invention relates to non-transitory computer-readable media with computer-executable instructions embodied thereon that when executed by a computing system perform a method for improving power generation by a wind farm. The media includes instructions for providing self-optimizing control of an upstream turbine that optimizes the power output of the upstream turbine based on the combined power output of the upstream turbine and on the power output of at least one downstream turbine. The instructions may implement an extremum-seeking control strategy configured to seek a turbine operating parameter that maximizes the combined power output of the upstream turbine and the downstream turbine. The media may further include instructions for identifying the downstream turbine as being downstream from the upstream turbine.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is an illustration of a wind farm turbine array, according to an exemplary embodiment;

FIG. 2 is a cutaway perspective view of a wind turbine, according to an exemplary embodiment;

FIG. 3 is a block diagram of an extremum-seeking control strategy, according to an exemplary embodiment;

FIG. 4 is an illustration of a wind farm turbine array, according to an exemplary embodiment;

FIG. 5 is a hierarchical representation of the wind farm turbine array of FIG. 1, according to an exemplary embodiment;

FIG. 6 is a block diagram of the processing circuit shown in FIGS. 1-2, according to an exemplary embodiment;

FIG. 7 is a flow chart of a process for using a cascade of self-optimizing controllers to maximize power in a wind farm turbine array, according to an exemplary embodiment;

FIG. 8 is a flow chart of a process for controlling a wind farm turbine array, according to an exemplary embodiment;

FIG. 9 is a block diagram of power maximization logic using self-optimizing controllers in a wind farm turbine array, according to an exemplary embodiment;

FIG. 10 is a block diagram of power maximization logic using a supervisory wake field controller and self-optimizing controllers in a wind farm turbine array, according to an exemplary embodiment;

FIG. 11 is another block diagram of power maximization logic using a supervisory wake field controller and self-optimizing controllers in a wind farm turbine array, according to an exemplary embodiment;

FIG. 12 is still another block diagram of power maximization logic using a supervisory wake field controller and self-optimizing controllers in a wind farm turbine array, according to an exemplary embodiment;

FIG. 13 is a schematic of the single actuator disc model and air stream tube, according to an exemplary embodiment;

FIG. 14 is a plot of the power coefficient as a function of the axial induction factor for the single actuator disk model, according to an exemplary embodiment;

FIG. 15 is an illustration of a wind farm with two turbines, according to an exemplary embodiment;

FIG. 16 is a plot of the power coefficient for a two turbine wind farm versus the axial induction factors for an upwind and downwind turbine, according to an exemplary embodiment;

FIG. 17 is a table of axial induction factors that maximize power output and of the respective maximum power coefficients, according to an exemplary embodiment; and

FIG. 18 is a contour plot of the power coefficient versus the axial induction factors for the two turbine wind farm, according to an exemplary embodiment.

### DETAILED DESCRIPTION

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

Embodiments of the present disclosure include a computer system for a wind farm that has been configured to maximize power generation by utilizing a cascade of self-optimizing controllers. Each self-optimizing controller attempts to optimize itself based on the power output of the turbine with which it is associated and, when there is at least one downstream turbine, on the power output of the downstream turbine(s). Utilizing a cascade of self-optimizing controllers is intended to improve overall power generation by the wind farm without the use of computationally expensive turbine wake models. Self-optimizing control strategies, such as extremum-seeking control, allow for a controller to find (i.e., “seek”) the optimum operating parameters of a turbine, without knowledge of the actual wake interactions.

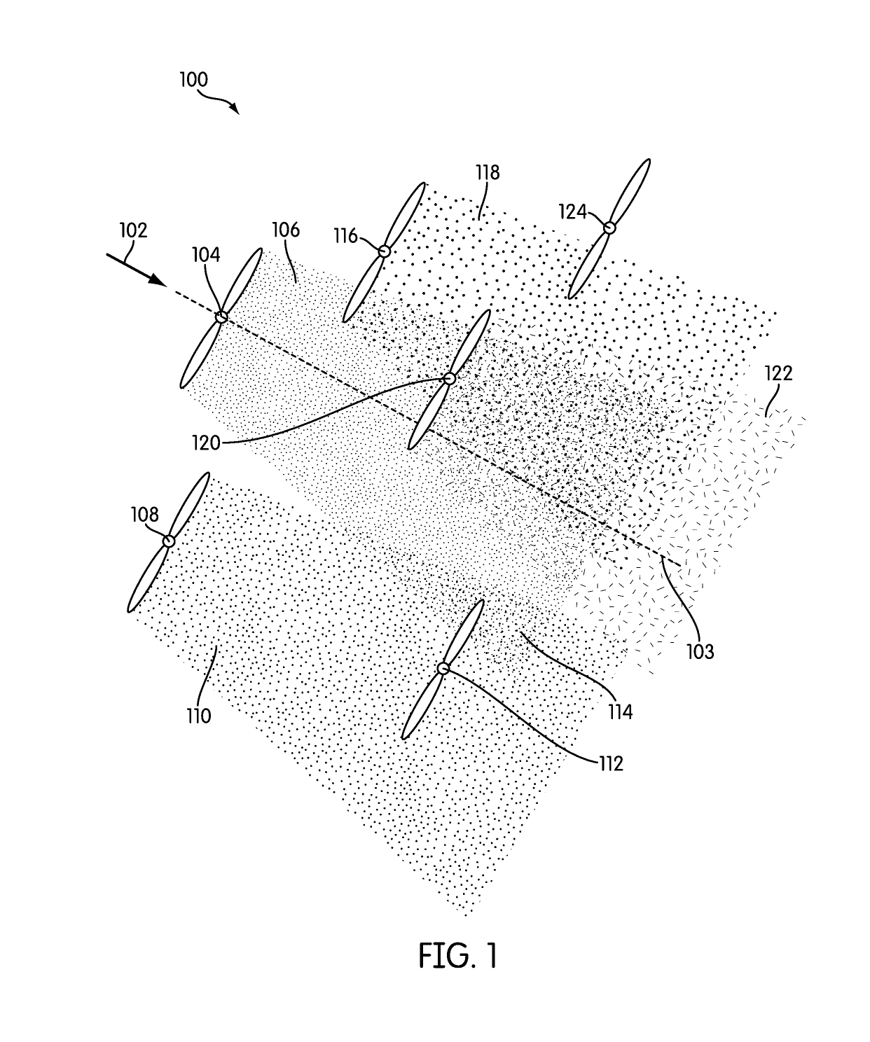

Referring now to FIG. 1, a wind farm turbine array 100 is shown, according to an exemplary embodiment. Wind farm turbine array 100 is shown to include a number of turbines 104, 108, 112, 116, 120, and 124, which convert wind 102 into electrical energy. In general, a wind farm turbine array is a set of two or more turbines and may be a subset of a larger array, or may include all of the turbines in a particular wind farm. For example, wind farm turbine array 100 may be a subset of a larger wind farm containing even more turbines, or may itself encompass all of the turbines in the wind farm.

Wind 102 approaches wind farm turbine array 100 at a velocity (V_{w}) along wind direction 103. As wind 102 reaches turbines 104, 108, 112, 116, 120, and 124, it causes the rotors of the turbines to rotate, thereby capturing wind power as mechanical energy. In turn, turbines 104, 108, 112, 116, 120, and 124 each include a generator coupled (e.g., mechanically linked) to their rotors, allowing the captured mechanical energy to be converted into electricity.

As shown, turbines 104, 108, 112, 116, 120, and 124 in wind farm turbine array 100 face wind 102, i.e., their rotor disks are normal or approximately normal to wind direction 103. Facing wind 102 allows turbines 104, 108, 112, 116, 120, and 124 to generate more electricity than from other orientations. Some or all of turbines 104, 108, 112, 116, 120, and 124 in wind farm turbine array 100 are able to adjust their positions (e.g., axis of rotation) when wind direction 103 changes. Doing so allows wind farm turbine array 100 to increase its power output. In some alternative embodiments, some or all of the turbines of a wind farm are fixed relative to an expected wind direction.

In addition to (or as an alternative to) adapting to new wind directions, each of turbines 104, 108, 112, 116, 120, and 124 may increase their individual power generation by regulating operating parameters such as torque and the pitch angle of their rotor blades. Regulating these parameters to maximize power generation by wind farm turbine array 100 conventionally requires knowledge of the wind dynamics arriving at each of the turbines in wind farm turbine array 100. Torque, for example, can be controlled to increase or decrease the speed of the rotor as a function of the speed of wind 102. However, because the wind dynamics experienced by each of turbines 104, 108, 112, 116, 120, and 124 differ due to wake, the optimal generator torque may be different from turbine to turbine.

As illustrated in FIG. 1, a number of turbines in wind farm turbine array 100 are in the wake of one or more other turbines. As shown, turbine 104 creates wake 106, turbine 108 creates wake 110, and turbine 116 creates wake 118. Each of these wakes affects the wind dynamics experienced by downstream turbines. Turbine 120 creates wake 122, which does not impact downstream turbines. In some cases, a turbine may be in a single wake of another turbine. For example, turbine 124 is influenced only by wake 118 of turbine 116. However, wakes may also overlap, leading to complicated wind profile across the rotor disk of downstream turbines. For example, turbine 112 is subject to the wind profile superposed by wake 110 and wake 106 (region 114). In another example, the wind profile at turbine 120 is superposition of wakes 106 and 118. In some cases, a turbine may even be indirectly downstream from an upstream turbine. For example, turbine 124 is not directly in wake 106 of turbine 104, but is still influenced by it because wake 106 affects wake 118 of turbine 116.

To accommodate for the influence of turbine wakes, some efforts have been made to model wake interactions. In general, these wake models may be broken up into two general categories: near-field wake and far-field wake. Near-field wake models attempt to model the interaction of closely-spaced turbines. Far-field wake models, in contrast, attempt to model the interaction of farther spaced turbines. Existing models typically rely on a number of assumptions that fail to precisely model the wake interactions. For example, some models assume a linearly expanding wake and uniform wind speeds. Non-linear approaches have been proposed, but often fail to account for some non-linear factors, such as uneven terrain. Even in situations where conventional model-based approaches have successfully modeled a wind farm for one period in time, model-based approaches often fail to account for changing conditions (e.g., changing mechanical conditions, changing climate conditions, etc.).

Some embodiments of the present invention advantageously avoid the use of wake models entirely by using a cascade of self-optimizing controllers for a plurality of turbines. A self-optimizing controller for an upstream turbine optimizes the power output of the upstream turbine based on the power output of the upstream turbine and on the power output from at least one downstream turbine.

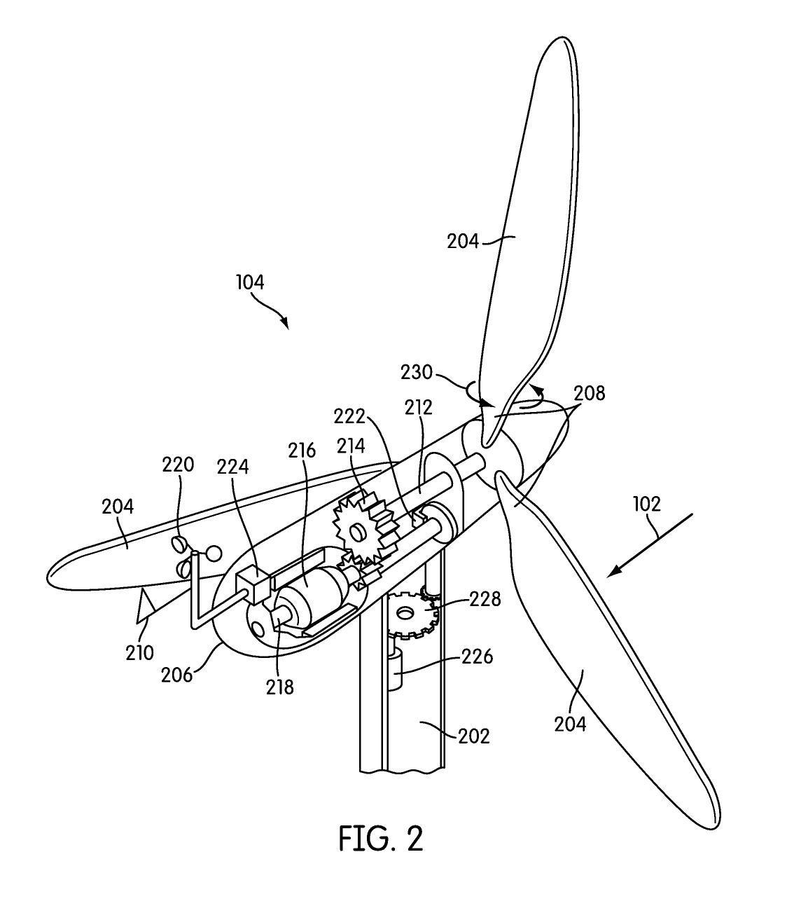

Referring now to FIG. 2, an illustration of wind turbine 104 is shown, according to an exemplary embodiment. In some embodiments, wind turbine 104 is a variable-pitch, variable speed turbine, meaning that both the blade pitch and the speed of the turbine can be controlled. As wind 102 is applied to turbine 104, aerodynamic forces induced along blades 204 cause a torque to be applied to rotor 208 about the axis of low speed shaft 212, thereby harvesting the wind power as mechanical energy. The rotation of low speed shaft 212 drives gears 214 which, in turn, cause high-speed shaft 218 to rotate. High-speed shaft 218 is connected to brake 222, which may be applied to regulate the rotation of high-speed shaft 218. High-speed shaft 218 is also connected to generator 216, which converts the rotational energy of high-speed shaft 218 into electrical energy.

Turbine 104 also includes tower 202, which supports nacelle 206. Nacelle 206 houses low-speed shaft 212, gears 214, high-speed shaft 218, brake 222, and generator 216. In some embodiments, turbine 104 also includes yaw motor 226 and yaw drive 228. In some embodiments, if the direction of wind 102 changes significantly in terms of ten-minute integration, yaw motor 226 may be controlled to apply force to yaw drive 228, in order to reposition rotor 208 to face the new wind direction.

Turbine 104 further includes processing circuit 224, which processes measurement data and provides control commands to the various components of turbine 104. For example, processing circuit 224 may receive wind speed data from anemometer 220 or wind direction data from wind vane 210. Processing circuit 224 may provide control commands to yaw motor 226 to regulate the yaw angle (e.g., a relative measure of the difference between the direction faced by the primary rotational axis of rotor 208 and the direction of wind 102). The yaw angle may be calculated based on wind direction data received from wind vane 210. For example, processing circuit 224 may provide a control command to yaw motor 226 to minimize the yaw angle of rotor 208. The processing circuit 224 may allow for some margin of error, refraining from making adjustments, e.g., unless the yaw angle exceeds an acceptable angle threshold (e.g., 5°, 10°, etc.). In this way, processing circuit 224 is able to keep rotor 104 facing the direction of wind 102, thereby increasing the power generation capabilities of turbine 104. In many cases, processing circuit 224 can increase the power generation capabilities of turbine 104 by intermittently making adjustments such that rotor 208 is caused to face the direction of the wind 102.

Processing circuit 224 may also or alternatively control other operating parameters of turbine 104 that affect power generation. For example, the blade pitch angle 230 of blades 204 and the rotor speed of blades 204 (or equivalently, the tip speed ratio or torque) may be regulated to further optimize the power generated by turbine 104. The blade pitch angle is the angle between the rotor plane and the chord line of blades 204. As the effective relative wind that hits an element of blades 204 is composition of the wind speed at the rotor disk and the local linear speed of the blade element, the actual angle of attack of the blade under wind 102 is determined by both the pitch angle, the wind speed and the rotor speed. The tip speed ratio of blades 204 refers to the ratio of the linear speed at the tip of blades 204 with respect to the velocity of wind 102. For each turbine, there are combinations of pitch and rotor speed (or tip-speed ratio) values that maximize the capture of energy from the wind. In some embodiments, for wind turbine control, the rotor speed can be better alternative than the tip-speed ratio if the wind measurement is inaccurate and/or unreliable.

According to an exemplary embodiment, optimizing the energy capture of a whole wind farm cannot be achieved by simply optimizing the operation of one single turbine. As the efficiency of power generation is determined by the axial induction factor or equivalently the wind speed deficit, maximizing the power generation of one turbine alone may also change the wind speed arriving at its downwind turbines, which leads to disadvantageous wind speed deficit for the downstream turbines. As consequence, the overall power generation by the wind farm turbine array can be potentially reduced.

In some embodiments, processing circuit 224 is configured using a self-optimizing controller to maximize the combined power output of turbine 104 and a downwind turbine (e.g., turbine 116 shown in FIG. 1). Such an embodiment may advantageously allow multi-turbine portions of the wind farm turbine array to be optimized without the use of actual models for the wake dynamics. Processing circuit 224 receives power information regarding the downwind turbine wirelessly or via a hardwired connection. Advantageously, the optimization of the power generation by the wind farm turbine array is performed at the individual turbine level (e.g., as part of a distributed control strategy). In other embodiments, processing circuit 224 may communicate with a remote server that coordinates control over the individual turbines (the server implementing the extremum seeking control strategy and merely receiving inputs from and providing outputs to the individual turbines). One type of self-optimizing control strategy for use with the present invention is an extremum seeking control strategy.

In general, extremum seeking control (ESC) refers to a class of self-optimizing control strategies that can dynamically search for the unknown and/or time-varying inputs of a system in order to optimize the system to a certain performance index. In some ways, ESC can be considered a dynamic realization of gradient searching through the use of dithering signals. The gradient of the system output with respect to the system input is typically obtained by slightly perturbing the system operation and applying a demodulation measure. Optimization of system performance can be obtained by driving the gradient towards zero by using an integrator in the closed-loop system. ESC is also a non-model based control strategy, meaning that a model for the controlled system is not necessary for ESC to optimize the system. In the embodiments described herein, an extremum seeking controller for a wind farm turbine uses controlled perturbations in one or more turbine characteristics (e.g., rotor direction) to seek a maximum power output of the turbine and one or more downwind turbines.

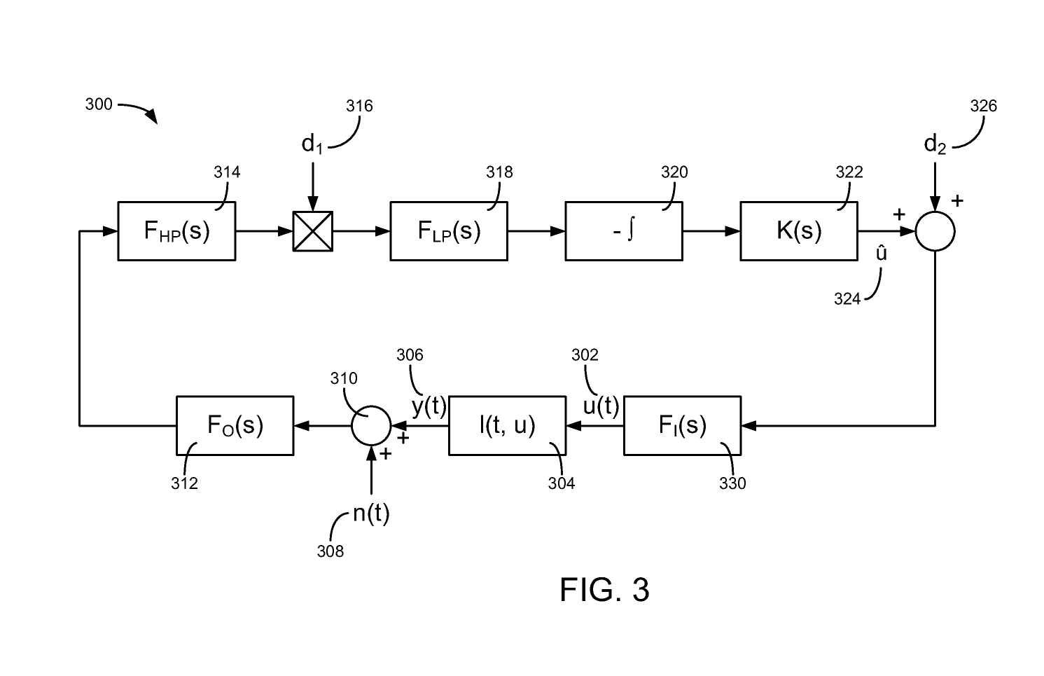

Referring now to FIG. 3, a block diagram of an ESC strategy 300 is shown, according to an exemplary embodiment. At the core of ESC strategy 300 is a cost function 304 (e.g., a performance map), denoted l(t, u), which varies both by time and by input parameter 302, denoted u(t). Typically, cost function 304 may be entirely unknown, allowing the ESC strategy 300 to operate without the use of a model of the system. Input parameter 302 may also be an m-dimensional real number vector that varies with time, allowing for multivariable control.

Transfer functions that correspond to the input and output dynamics of the plant (i.e., the controlled operating parameters of the turbine) are also utilized in ESC strategy 300. Input transfer function 330 represents the input dynamics of the plant and produces input parameter 302. Plant measurements may be taken by measurer 310 (e.g., one or more sensors, data analyzers, etc.), to provide output 306 of cost function 304, denoted y(t). Output 306 and may also contain a noise signal 308, denoted n(t). Output transfer function 312 represents the output dynamics of the plant.

In order to seek the optimal value for input 302, a dither signal 326 and a demodulation signal 316 are added to the system. For example, dither signal 326 may be of the form:

d₂(t)=[a₁ sin(ω₁t+α₁) . . . aₘ sin(ωₘt+αₘ)]

where ωᵢ (i=1, . . . , m) is the dithering frequency for the i^{th} input channel, aᵢ is the amplitude of the signal on the i^{th} channel, and αᵢ is the phase angle introduced intentionally between dither signal 326 and demodulation signal 316. Similarly, demodulation signal 316 may be of the form:

d₁(t)=[sin(ω₁t) . . . sin(ωₘt)]

Dither signal 326 contains perturbations, which allow for ESC strategy 300 to determine a gradient for cost function 304. High pass filter 314, demodulation signal 316, and low pass filter 318 operate to determine a signal proportional to the gradient,

$$\frac{\partial l}{\partial u} ( \hat{u} ) ,$$

where î denotes estimated control input 324 based on the gradient estimation. Integrator 320 may be used in ESC strategy 300 to reduce the gradient to zero, thereby always seeking out the value of input parameter 302 that maximizes or minimizes cost function 304 in the closed-loop system, depending on whether the gain of compensator 322 is negative or positive, respectively. Compensator 322 may additionally be employed to enhance transient performance by compensating input and output dynamics.

Integral windup is a source of potential error for ESC strategy 300 because of its use of integrator 320. If an actuator saturation condition exists, i.e., an actuator controlled by ESC strategy 300 cannot physically go beyond a certain limit, integral windup may occur, causing the error in the loop to continually increase. For example, the blade pitch angle and the rotor speed may both be physically limited, leading to an actuator saturation condition. Anti-windup techniques may be incorporated into ESC strategy 300, to mitigate the effects of integral windup. For example, a back calculation may be used at the input to integrator 322 that detects saturation conditions and disables ESC strategy 300 until the saturation condition is removed.

Another potential source of inefficiency in ESC strategy 300 is when an abrupt change occurs, shifting the optimal operating point of cost function 304. For example, the wind speed or direction may suddenly change, thereby changing the optimal operating conditions for power generation. In such a case, ESC strategy 300 may take longer to converge to the new extremum. One way to enhance the convergence would be to utilize a gradient detector that detects gradient changes that are above a specified threshold and resets the input to integrator 320 if the threshold is exceeded. Another way to enhance the convergence would be to use a step change detector and resetting logic at the input to high pass filter 314, in order to reset the input to high pass filter 314 if a step change is detected.

In the context of wind turbine applications, a multiple input extremum seeking control strategy may be used to converge the operating parameters of a turbine to maximize its power generation. For example, a two variable ESC loop that maximizes power generation of a turbine using pitch angle and torque as inputs is described in the article, “Maximizing Wind Turbine Energy Capture using Multivariable Extremum Seeking Control” by J. Creaby, Y. Li, and J. Seem, which is hereby incorporated by reference. In such a scheme, however, power generation is only maximized at the individual turbine level, meaning that the power generation at the array level may suffer due to the effects of turbine wakes. Various optimization techniques exist to optimize the parameters for a set of problems. For example, dynamic programming is one technique that affords a way to globally optimize sets of computational problems using recursion to minimize a cost function for sub-problems. Also known as a Bellman equation, optimization can be achieved by making choices in sequence that optimize the sub-problems. Using such techniques, a cascade of self-optimizing controllers may be utilized to optimize the power generation for an entire wind farm turbine array.

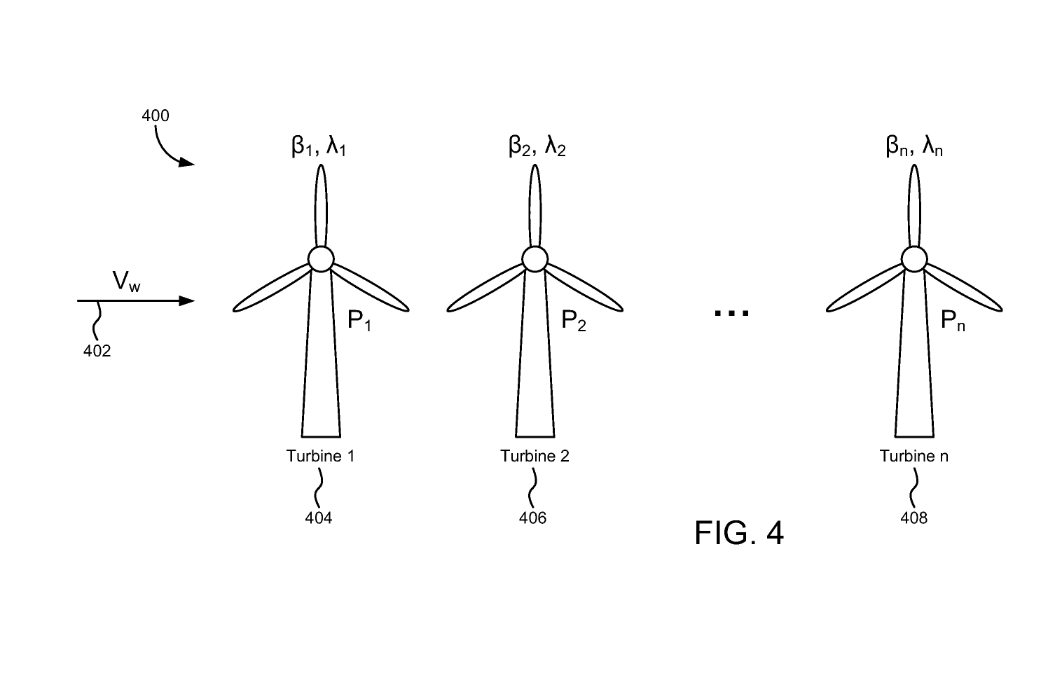

Referring now to FIG. 4, an illustration of wind farm turbine array 400 is shown, according to an exemplary embodiment. Wind farm turbine array 400 includes n number of interrelated turbines, where n is greater than or equal to two. At minimum, turbine array 400 includes upstream turbine 404, which experiences wind 402 at wind velocity V_{w} along a particular trajectory and does not experience wake effects from another turbine. Also, at minimum, downstream turbine 408 is influenced by the wake of upstream turbine 404. Wind farm turbine array 400 may also include or more intermediary turbines 406 that are downstream from turbine 404 and upstream from turbine 408. Downstream turbine 408 and intermediary turbines 406 may be in a variety of positions relative to their upstream counterparts, i.e., a downstream turbine may be directly behind an upstream turbine or positioned in such a location that it is still influenced by the wake of the upstream turbine.

Each of turbines 404, 406, and 408 have operational parameters that may be used to optimize power generation. For example, pitch angle (βᵢ) and rotor speed (Ωᵢ) for the i^{th} turbine may be used to optimize its power generation (Pᵢ). Since the turbines in wind farm turbine array 400 are interrelated, optimization at the array level may be achieved by solving the following Bellman equation:

$$\{ {β}_{1}^{*} , {Ω}_{1}^{*} , … , {β}_{n}^{*} , {Ω}_{n}^{*} \} = {arg max}_{\{ ( {β}_{i} , {Ω}_{i} ) , i = 1 , … , n \}} {\sum }_{l = 1}^{n} {P}_{i} ( {β}_{i} , {Ω}_{i} )$$

where βᵢ* and Ωᵢ* are the optimal pitch angles and rotor speeds of the i^{th} turbine, respectively, and Pᵢ is the corresponding power output. In other words, the goal of optimization at the array level is to find those operating parameters for each turbine that maximize the power generation of the entire array, not just for the individual turbines. In some embodiments, the tip-speed ratio (λᵢ), may be used to optimize the power generation of the i^{th} turbine. In the description of those embodiments, the notations of Ω (rotor speed) used herein are replaced by λ (tip-speed ratio).

In some embodiments, the operating parameters may be determined following Bellman's approach for optimization. As a starting condition for the optimization process, the most downwind turbine may be optimized first by finding the pitch angle and rotor speed that maximizes its power. In other words, the initial condition can be determined by solving:

$$\{ {β}_{n}^{*} , {Ω}_{n}^{*} \} = {arg max}_{{β}_{n} , {Ω}_{n}} {P}_{n} ( {β}_{n} , {Ω}_{n} )$$

where βₙ* and Ωₙ* are the optimal pitch angles and rotor speeds of turbine 408 (e.g., the n^{th} turbine of wind farm turbine array 400), respectively, and Pₙ is the power output of the turbine.

A self-optimizing controller may be used to solve for the optimal parameters, according to some embodiments. For example, a two-input ESC can be used to determine the optimal pitch angle and rotor speed that maximize the power generation by the most downwind turbine in wind farm turbine array 400. The ESC, using a model-free control strategy, allows the power generation by the most downwind turbine to be maximized without using a model of the wakes of the turbines that are upstream from it.

A turbine that is upstream from turbine 408 may be optimized such that the combined power generation of the upstream turbine and any of its downstream turbines is maximized. For example, the optimization problem for the (n−1)^{th} turbine may be viewed as follows:

$$\{ {β}_{n - 1}^{*} , {Ω}_{n - 1}^{*} \} = {arg max}_{{β}_{n - 1} , {Ω}_{n - 1}} [ {P}_{n - 1} ( {β}_{n - 1} , {Ω}_{n - 1} ) + {P}_{n} ( {β}_{n} , {Ω}_{n} ) ]$$

where βₙ₋₁* and Ωₙ₋₁* are the optimal pitch angles and rotor speed (or equivalently the tip speed ratio) of the turbine directly upstream from turbine 408, respectively, and Pₙ₋₁ is the power output of the upstream turbine. In some embodiments, the search for βₙ₋₁* and Ωₙ₋₁* can be performed any time during the operation, i.e., even before the search for βₙ* and Ωₙ* for the downstream turbine is settled. In some embodiments, the search for βₙ₋₁* and Ωₙ₋₁* would be settled only after the search for the optimal operating parameter of the downstream (i.e., βₙ* and Ωₙ*) is settled. In this way, the optimal parameters for the upstream may be determined such that they maximize the combined power generation of both the upstream turbine and the downstream turbine.

According to embodiments of the present invention, a self-optimizing controller is used to determine the optimal operating parameters for an upstream turbine. For example, a two-input ESC can again be used to determine the optimal parameters for an upstream turbine, such that the combined power generation of the upstream turbine and any downstream turbines from it is maximized. In such a case, dithering frequencies used in the ESC (e.g., ω_{β,i} and ω_{Ω,i}) may be different between adjacent turbines. In some embodiments, for sufficiently spaced turbines, any perturbations from the upstream dither signal will have vanished before reaching the downstream turbine due to turbulent diffusion. Therefore, the dither action in an upstream turbine would not lead to dithered wind speed at its downstream peers.

Farther upstream turbines may be optimized in a similar manner as the (n−1)^{th} turbine, i.e., by determining its optimal operating parameters such that the combined power generation of it and all downstream turbines is maximized. In general, the kth upstream turbine may be optimized as follows:

$$\{ {β}_{k}^{*} , {Ω}_{k}^{*} \} = {arg max}_{{β}_{k} , {λ}_{k}} [ {P}_{k} ( {β}_{k} , {Ω}_{k} ) + {\sum }_{i = k + 1}^{n} {P}_{i} ( {β}_{i} , {Ω}_{i} ) ]$$

where βₖ* and Ωₖ* are the optimal pitch angles and rotor speeds of kth turbine and Pᵢ is the power output of the upstream turbine or any of the turbines downstream from it. The search for the optimal solution for the kth turbine can proceed while all the downwind turbines are searching for their optimal solutions. The final optimal solution for the kth turbine may be achieved after all the downstream turbines are at their optimal solution.

Again, a self-optimizing controller may be used to solve for the i^{th} upstream turbine, allowing the entire wind farm turbine array 400 to be optimized using a cascade approach. This decentralizes the optimization problem for the array into many lower-dimensional problems, allowing for their computations to also be decentralized for faster processing. For example, the array optimization problem may be solved at a supervisory server that oversees the operation of multiple turbines, at the individual turbine controllers, or any combination thereof.

Since a cascade of self-optimizing controllers is a self-adapting control approach, it is also able to maximize the power generation of wind farm turbine array 400, even if a turbine is malfunctioning. Model-based approaches make assumptions as to the wake dynamics of upstream turbines. However, if an upstream turbine is malfunctioning, these assumptions may no longer be valid, leading to lower power generation by the array. In contrast, a cascade of self-optimizing controllers is able to adapt in the event of a turbine malfunction. For example, if turbine 406 is malfunctioning such that its power generation is zero, the self-optimizing controller for turbine 404 will still optimize its operating parameters to maximize the combined power generation of the turbines in wind farm turbine array 400.

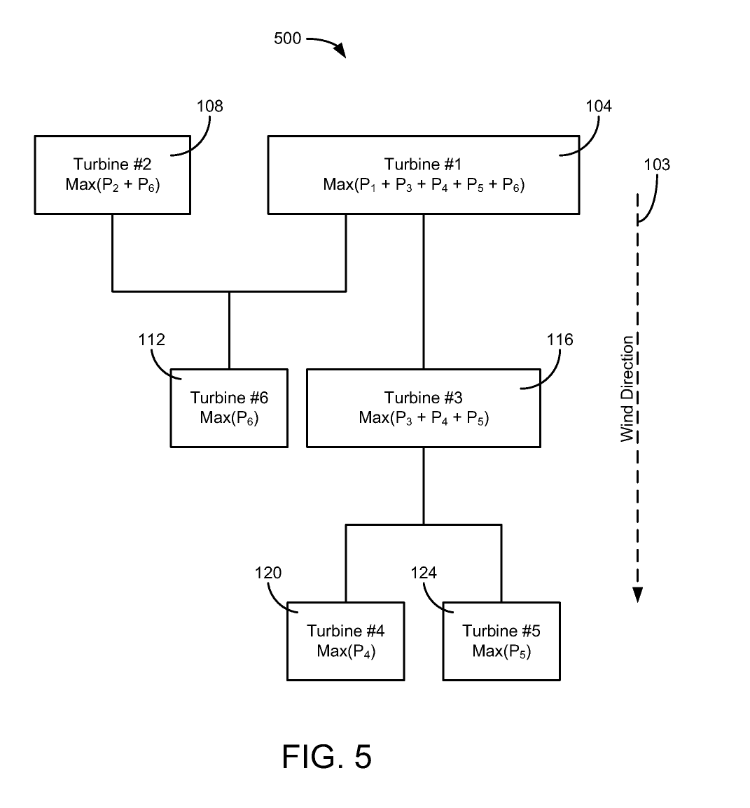

Referring now to FIG. 5, a hierarchy 500 of the wind farm turbine array 100 in FIG. 1 is shown, according to an exemplary embodiment. Hierarchy 500 categorizes the turbines in wind farm turbine array 100 based on their wake information. For example, turbines 112, 116, 120, and 124 are all affected by the wake of turbine 104. While turbine 124 is not directly in the wake of turbine 104, as shown in FIG. 1, it is in the wake of turbine 116, which itself is in the wake of turbine 104. Therefore, turbine 124 may still be considered to be downstream from turbine 104. In another example, turbine 112 is affected by the wakes of both turbine 108 and turbine 104.

Hierarchy 500 may be used as part of a cascade approach to optimizing wind farm turbine array 100. Since turbines 112, 120, and 124 are all terminal downwind turbines (i.e., their wakes do not affect other turbines), self-optimizing controllers may be used to determine the operating parameters that maximize the power generation of each of turbines 112, 120, and 124, individually. For example, a two-input ESC may be used to determine the pitch angle and rotor speed parameters that maximizes power generation in each of turbines 112, 120, and 124.

The wake of turbine 116 affects both turbines 120 and 124, which are downstream from turbine 116. Therefore, the optimal operating parameters of turbine 116 are those that maximize the combined power generation of turbines 116, 120, and 124. Similarly, the optimal parameters of turbine 108 are those that maximize the combined power generation of turbines 108 and 112 and the optimal parameters of turbine 104 are those that maximize the combined power generation of turbines 104, 112, 116, 120, and 124. A self-optimizing controller can again be used to determine the optimal operating parameters that maximize the combined power outputs. In this way, a cascade of self-optimizing controllers is able to maximize power generation by the wind farm turbine array.

Hierarchy 500 may be constructed in any number of different ways. In one embodiment, hierarchy 500 may be represented using a table or other data structure stored in a memory. For example, hierarchy 500 may be constructed based on wind direction 103. If the turbines in wind farm turbine array 100 are able to adjust their positions to face the wind, the corresponding hierarchy information may retrieved from a table relating different wind positions to different hierarchy information, in order to determine a hierarchy for use by the self-optimizing controllers of the wind farm. Similarly, a table or other data structure relating hierarchy information to the actual turbine positions (e.g., angles, compass directions, etc.) may be used to determine hierarchy 500.

In some embodiments, the hierarchy information used to determine hierarchy 500 may be predetermined, based on the design of wind farm turbine array 100. For example, the locations and spacing of the turbines in wind farm turbine array 100 may be used to determine hierarchy information based on wind direction or turbine position. In further embodiments, the hierarchy information may be determined using a self-learning approach that observes how changes in wind direction affect the individual turbines.

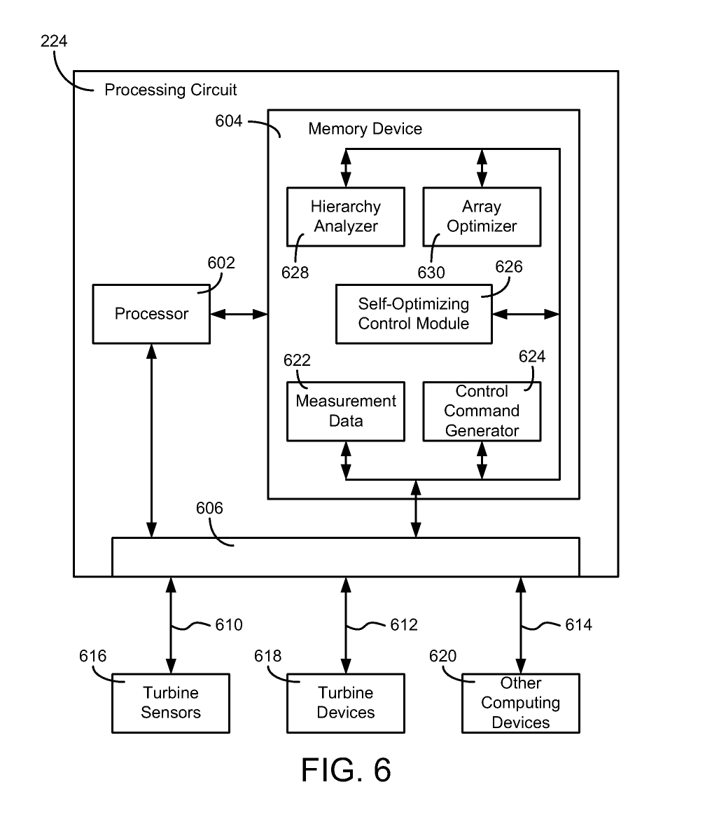

Referring now to FIG. 6, a detailed block diagram of the processing circuit 224 in FIG. 2 is shown, according to an exemplary embodiment. Processing circuit 224 is shown to include processor 602 and memory device 604. Processor 604 may be a general purpose or specific purpose processor, an application specific integrated circuit (ASIC), one or more field programmable gate arrays (FPGAs), another suitable processing component, or a group of processing components. Processor 602 is communicatively coupled to memory device 604 and configured to execute computer code or instructions stored in memory device 604. Memory device 604 may be one or more memory devices for storing data and/or computer code for completing and/or facilitating the various processes described in the present disclosure. For example, memory device 604 may include a RAM, ROM, hard drive storage, non-volatile memory, flash memory, optical memory, a remote server, computer readable media (e.g., a CD-ROM, magnetic storage tape, floppy, etc.), or any other suitable memory for storing software objects and/or computer instructions. When processor 602 executes instructions stored in memory device 604, processor 602 generally configures processing circuit 224 to complete the activities and functions described herein.

Processing circuit 224 is shown to include interface 608, which may provide data connections 610, 612, and 614 between processing circuit 224 and turbine sensors 616, turbine devices 618, and other computing devices 620, respectively. Data connections 610, 612, and 614 may be any combination of hardwired connections (e.g., via a cable, data bus, etc.) and/or wireless connections (e.g., cellular, radio frequency, WiFi, etc). For example, interface 610 may provide a wired connection between processing circuit 224 and turbine sensors 616 and a wireless connection between processing circuit 224 and other computing devices 620. In some embodiments, data connections 610, 612, and 614 may also include any number of intermediary circuits or devices. For example, data connection 614 may include any number of routers, gateways, servers, or other computing devices that relay communication data between processing circuit 224 and other computing devices 620.

Turbine sensors 616 may include any number of sensors that determine conditions related to the operation of turbine 104. For example, turbine sensors 616 may include any number of temperature sensors, pressure sensors, speed sensors, position sensors, flow rate sensors, anemometers, or wind vanes. Turbine devices 618 may include any number of non-sensor devices of the turbine that provide data to processing circuit 224 and/or receive control commands from processing circuit 224. For example, turbine devices 618 may include yaw motor 226, brake 222, generator 216, or another processing circuit that provides direct control over a turbine device. Other computing devices 620 may include any number of servers, computers, or processing circuits located remotely from the turbine. For example, other computing devices 620 may include one or more processing circuits located at another turbine or a supervisory server that oversees the operation of multiple turbines.

Memory device 604 is also shown to include measurement data 622. Measurement data 622 may include sensor data received from turbine sensors 616 via interface 606. Measurement data 622 may also include measurements from other turbines (e.g., received from other computing devices 620), and/or measurements derived from sensor data. For example, the tip speed of a turbine blade may be calculated using data indicative of the rotational speed of the blade and the wind velocity measured by an anemometer (e.g., anemometer 220, other computing devices 620, etc.). Other examples of measurements in measurement data 622 include wind direction, pitch angle, and turbine power generation.

Memory device 604 is further shown to include hierarchy analyzer 628. Hierarchy analyzer 628 generates hierarchy data, i.e., data indicative of which turbines are downstream from turbine 104. In some embodiments, hierarchy analyzer 628 may include one or more tables and/or data structures that relate turbine location data to directional data. Directional data may be, for example, a wind direction or a direction faced by rotor 208 of turbine 104. The directional and hierarchy data may be preloaded into memory device 604, based on the layout of the wind farm turbine array. In other embodiments, hierarchy analyzer 628 may utilize a self learning routine (e.g., a Bayesian network, an artificial neural network, etc.) to determine turbine location information. In further embodiments, hierarchy analyzer 628 may use location or other data from other computing devices 620 to determine which turbines are currently downstream from turbine 104.

Memory device 604 is further shown to include array optimizer 630. Array optimizer 630 receives hierarchy data from hierarchy analyzer 628 and uses the hierarchy data to determine cascade data, i.e., a set of turbine power outputs to be maximized. The set of turbine power outputs may include a single turbine, a sub-array of turbines, or the full array of turbines. For example, if the hierarchy data received from hierarchy analyzer 628 indicates that no other turbines are currently downstream from turbine 104, array optimizer 630 may determine that only the power output of turbine 104 needs to be maximized. However, if one or more turbines are currently downstream, array optimizer 630 may determine that the combined power generation by turbine 104 and the downstream turbines needs to be optimized. This determination may be provided to self-optimizing control module so that the self-optimizing control module can work to optimize the combined power generation.

Memory device 604 is also shown to include self-optimizing control module 626. Self-optimizing control module 626 uses a self-optimizing control algorithm to determine optimal operating parameters for the turbine primarily associated with processing circuit 224. The optimal operating parameters for the turbine can be selected by the self-optimizing control module 626 by seeking to maximizes the combined power generation of the turbine and its downstream turbines (e.g., as determined by hierarchy analyzer 628 and/or array optimizer 630).

In some embodiments, self-optimizing control module 626 may utilize an ESC strategy. For example, self-optimizing control module 626 may use a two-input ESC to determine an optimal pitch angle and rotor speed (or equivalently the tip-speed ratio) that maximize the power generation of the set of turbines from array optimizer 630. In other embodiments, self-optimizing control module 626 may also or alternatively determine optimize other operating parameters (e.g., torque, rotor speed, etc.) also associated with the power generation by a wind turbine. If self-optimizing control module 626 is used to optimize the combined power generation of turbine 104 and one or more downstream turbines, self-optimizing control module 626 may also use power measurements from the downstream turbines (e.g., as received from other computing devices) in the self-optimizing control strategy.

Memory device 604 is further shown to include control command generator 624. Control command generator 624 generates control commands for turbine devices 618 using the operating parameters from self-optimizing control module 626. For example, if pitch angle and rotor speed (or equivalently the tip-speed ratio) are used as inputs to self-optimizing control module 626, self-optimizing control module 626 may work in conjunction with control command generator 624 to control one or both of these parameters. If self-optimizing control module 626 determines that an adjustment is needed to the pitch angle, for example, the control command generator 624 may provide a control signal via interface 606 to a device in turbine devices 618 that regulates the blade pitch angle.

Control command generator 624 may also control other conditions of turbine 104, in addition to those used by self-optimizing control module 626. For example, control command generator 624 may send a control command to a yaw motor (e.g., in turbine devices 618), based on wind direction and rotor direction data stored in measurement data 622. In this case, the control command may cause yaw motor 226 to adjust the direction that rotor 208 faces, in order to adjust the position of turbine 104 to face the oncoming wind 102.

In some embodiments, measurement data 622, control command generator 624, self-optimizing control module 626, hierarchy analyzer 628, and array optimizer 630 may be located on a remote computing device (e.g., as part of other computing devices 620). By way of example, other computing devices 620 may include one or more servers that provide supervisory control over turbine 104. In such a case, array optimizer 620 may use hierarchy data from hierarchy analyzer 628 to generate a set of turbine measurement data for each turbine. A server may use a self-optimizing control loop as described above to generate control signals for each of the turbines. In either case, a cascade approach is taken, whether physically distributed or within a single server, to optimize the wind farm turbine array using a self-optimizing control strategy.

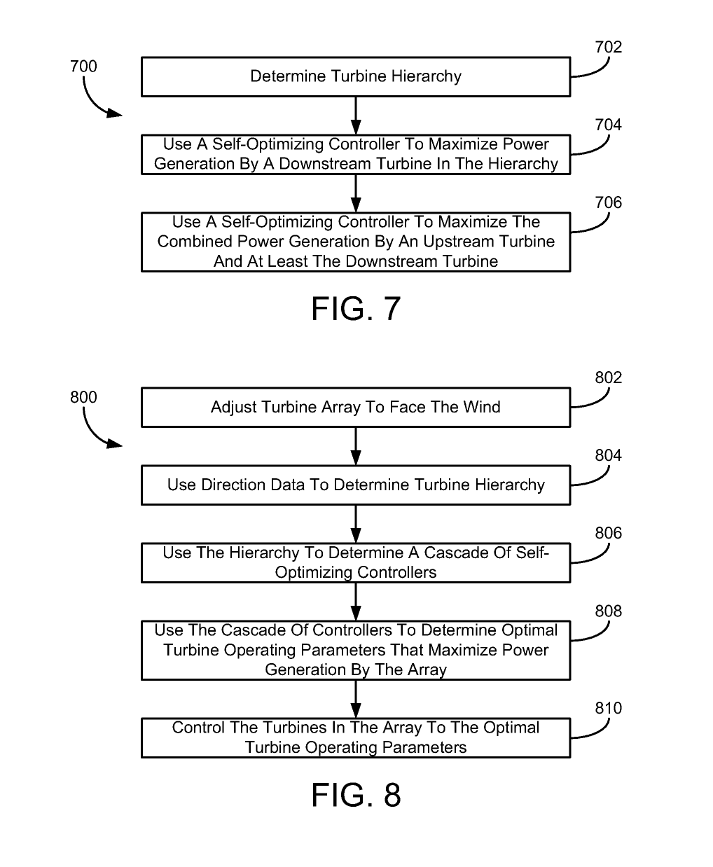

Referring now to FIG. 7, a process 700 for using a cascade of self-optimizing controllers to maximize power in a wind farm turbine array is shown, according to an exemplary embodiment. Process 700 includes determining a turbine hierarchy (step 702) based on the wind direction measurement. The turbine hierarchy may be any form of data that denotes which turbines are upstream and/or downstream from a given turbine. The turbine hierarchy may be for only two turbines (e.g., one upstream and one downstream turbine), a larger array of turbines, or for the entire wind farm. The turbine hierarchy may be determined, for example, based on the wind direction or the direction faced by the turbines, using a self-learning routine, or based on another method of determining the interrelationship of turbine wakes (e.g., a site employee could manually determine a wind-direction to hierarchy data set in memory of a centralized site computer).

Process 700 also includes using a self-optimizing controller to maximize the power generation by a downstream turbine in the hierarchy (step 704). Based on the hierarchy, downstream turbines can be identified. In one embodiment, the self-optimizing controller is used to maximize the power generation of a terminal downstream turbine (e.g., a turbine that is influenced by the wake of one or more upstream turbines, but does not affect any downstream turbines). The self-optimizing controller may be, for example, an ESC loop that seeks out the turbine operating parameters that maximize the power generation of the downstream turbine. The operating parameters may be one or more variables associated with the turbine that can be controlled to maximize the turbine's power generation. For example, blade pitch angle, rotor speed, torque, tip speed ratio, and other parameters may be optimized.

Process 700 further includes using another self-optimizing controller to maximize the combined power generation by an upstream turbine and at least the downstream turbine (step 706). Rather than maximizing the power generation of the upstream turbine alone, a self-optimizing controller is used to maximize the combined power generation of a cluster of interrelated turbines (e.g., the upstream turbine and one or more downstream turbines from the upstream turbine). For example, an ESC strategy may be used to maximize the combined power generation by determining the optimal operating parameters for the upstream turbine. This results in optimization of the combined power generation for the hierarchy because maximizing the power output of an upstream turbine alone may result in decreasing the power output of a downstream turbine. In this way, the combined power generation by the turbines may be maximized using a cascaded approach.

Referring now to FIG. 8, a process 800 for controlling a wind farm turbine array is shown, according to an exemplary embodiment. Process 800 includes adjusting a turbine array to face the wind (step 802). If a change in the wind direction is detected, the turbines in the array may be rotated such that their rotors directly face the wind or are within a predefined threshold (e.g., a predefined offset of degrees from the a line normal to the wind direction, etc.). For example, each turbine may be rotated by a yaw motor to adjust the direction faced by its rotor.

Process 800 also includes using direction data to determine a turbine hierarchy (step 804). When the turbine array is adjusted to accommodate a change in wind direction, the set of turbines downstream from a given turbine may change. The direction data (e.g., the direction faced by the rotor of a turbine, the wind direction, etc.) may be used to determine the new turbine hierarchy. For example, if a turbine is oriented to face due west, it may have no downstream turbines. However, if the turbine is reoriented to face the northwest, it may have one or more downstream turbines.

Process 800 further includes using the hierarchy to determine a cascade of self-optimizing controllers (step 806). In an effort to maximize the power generation of the entire array, the operating parameters for an upstream turbine may be selected as calculated to maximize the combined power output of the upstream turbine and at least one turbine downstream from the upstream turbine. Terminal downstream turbines (i.e., those turbines that do not have downstream turbines) may be set to attempt to maximize their own power alone using a self-optimizing controller. Therefore, the hierarchy can be used to determine what power output each self-optimizing controller in the cascade is to attempt to maximize, whether it be for a single turbine or for a combination of turbines.

Process 808 additionally includes using the determined cascade of controllers to determine optimal turbine operating parameters that maximize power generation by the array (step 808). Operating parameters may be one or more controllable parameters that affect the power generation by the wind farm turbine array. For example, a two-input ESC strategy may be used to optimize the pitch angle and rotor speed (or equivalently the tip-speed ratio) of a turbine, based on the cascade information determined in step 806. If the turbine is upstream from other turbines, the ESC may be used to determine the pitch angle and rotor speed (or equivalently the tip-speed ratio) that maximize the power generation by the upstream turbine combined with the power generation of any downstream turbines from it. Otherwise, for terminal downstream turbines, an ESC may be used to optimize their power generation alone. In this way, the self-optimizing controllers for the turbines are cascaded to maximize the array's power output.

Process 800 further includes controlling the turbines in the array to the optimal turbine operating parameters (step 810). The turbine operating parameters used as inputs to the cascade of self-optimizing controllers may be controlled to approach their optimal values. For example, the pitch angle and rotor speed (or equivalently the tip-speed ratio) of a turbine may be adjusted via control commands. When the operating parameters for each turbine in the array approach their determined optimal values, power generation by the array approaches its maximum.

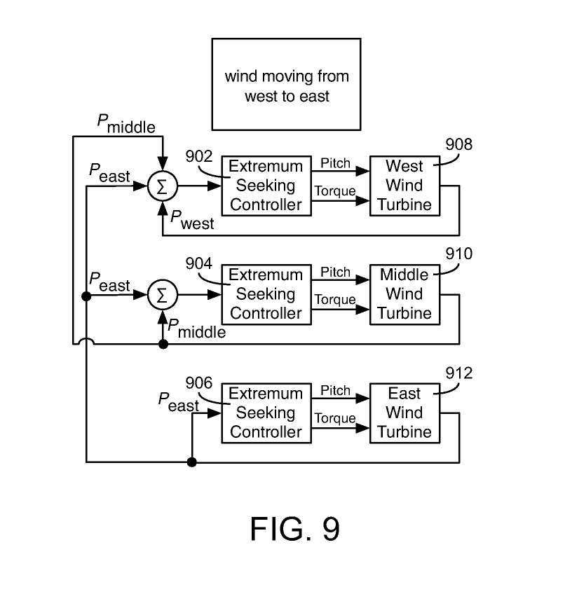

Referring to FIG. 9, a block diagram of the power maximization logic using self-optimizing controllers in a wind farm turbine array is shown, according to an exemplary embodiment. In the embodiment of FIG. 9, the wind farm turbine array (or a portion thereof) may have three turbines. The three turbines may be arranged in a west position (turbine 908), a middle position (turbine 910), and an east position (turbine 912). The direction of wind velocity may be from west to east. The turbines 908, 910, 912 face the wind, i.e., their rotors are normal or approximately normal to the wind direction. The west turbine 908 may be an upstream turbine, while middle turbine 910 and east wind turbine 912 may be downstream turbines. The three turbines may be arranged in such a manner that (a) east turbine 912 is affected by the wake of middle turbine 910 and west turbine 908; (b) middle turbine 910 is affected by the wake by of west turbine 908; and (c) west turbine is not affected by the wake of any turbine. In the embodiment of FIG. 9, the turbines in the wind farm turbine array may be equipped with extremum seeking controllers 902, 904, 906. The extremum seeking controllers 902, 904, 906 may determine the turbine operating parameters that maximize the combined power generated by the upstream turbine and the downstream turbine(s). The operating parameters are shown to be blade pitch angle and rotor speed, but may also or alternatively include, torque, tip speed ratio, and other parameters. The extremum seeking controllers 902, 904, 906 may be configured with all or a portion of the processing circuit of FIG. 6.

Extremum seeking controller 906 of the east wind turbine 912 may determine the optimum parameters of east wind turbine 912. As shown in FIG. 9, extremum seeking controller 906 may be configured to maximize power generated Pₑₐₛₜ by east wind turbine 912. According to an exemplary embodiment, the operating parameters may be blade pitch angle and torque. Thus, extremum seeking controller 906 determines a blade pitch angle and torque that maximizes power generated Pₑₐₛₜ by east wind turbine 912. As shown in FIG. 9, extremum seeking controller 906 may maximize only the power generated by east wind turbine 912 (and no other turbine). This may arise because east wind turbine 912 is the furthest downstream turbine, the wake effects of which do not affect any other turbine.

Extremum seeking controller 904 of middle wind turbine 910 may determine the optimum parameters of middle wind turbine 910. As shown in FIG. 9, extremum seeking controller 904 may be configured to maximize the combined power generated P_{middle} by middle wind turbine 910 and Pₑₐₛₜ by east wind turbine 912. According to an exemplary embodiment, the operating parameters may be blade pitch angle and torque. Thus, extremum seeking controller 904 determines a blade pitch angle and torque of middle wind turbine 910 that maximizes the combined power generated P_{middle} by middle wind turbine 910 and Pₑₐₛₜ by east wind turbine 912. In some embodiments, the operating parameters chosen for middle wind turbine 910 may not maximize the power generated P_{middle} when P_{middle} is considered in isolation. (That is, if the middle wind turbine 910 was the only turbine in an array, what parameters would be chosen to maximize its power output?) This is because east wind turbine 912 is downstream of middle wind turbine 910. Extremum seeking controller 904 is configured to maximize the combined power (and not necessarily the individual power) generated by the upstream turbine and the downstream turbine.

Extremum seeking controller 902 of the west wind turbine 908 may determine the optimum parameters of west wind turbine 908. As shown in FIG. 9, extremum seeking controller 902 may be configured to maximize the combined power generated P_{west} by west wind turbine 908, P_{middle} by middle wind turbine 910, and Pₑₐₛₜ by east wind turbine 912. According to an exemplary embodiment, the operating parameters may be blade pitch angle and torque. Thus, extremum seeking controller 902 determines a blade pitch angle and torque of west wind turbine 908 that maximizes the combined power generated P_{west} by west wind turbine 908, P_{middle} by middle wind turbine 910, and Pₑₐₛₜ by east wind turbine 912. In some embodiments, the operating parameters chosen for west wind turbine 908 may not maximize the power generated P_{west} when P_{west} is considered in isolation. This is because middle wind turbine 910 and east wind turbine 912 are downstream of west wind turbine 908. Extremum seeking controller 902 is configured to maximize the combined power (and not necessarily the individual power) generated by the upstream turbine and the downstream turbines.

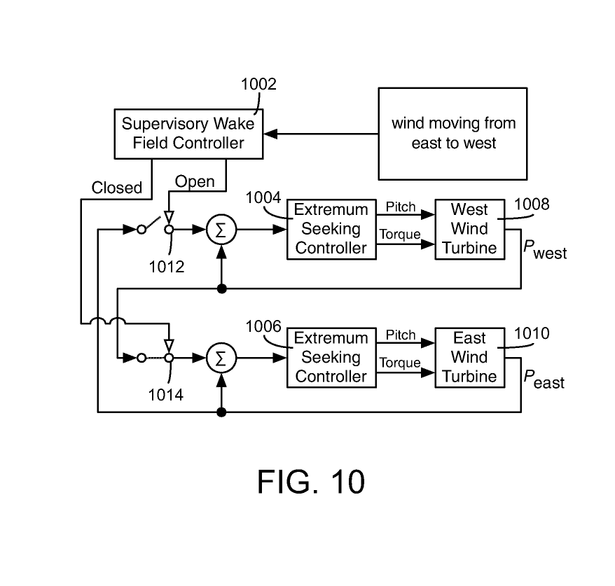

Referring to FIGS. 10-12, block diagrams of the power maximization logic using a supervisory wake field controller and self-optimizing controllers in a wind farm turbine array is shown, according to exemplary embodiments. In the embodiments of FIGS. 10-12, the wind farm turbine array (or a portion thereof) may have two turbines. The two turbines may be arranged in a west position and an east position (turbine 912). The two turbines may be arranged in such a manner that, depending on the direction of wind velocity, one turbine may feel the wake effect of the other. The direction of wind velocity varies in FIGS. 10-12. Depending on the direction of wind velocity, either west wind turbine or east wind turbine may be upstream or downstream of the other, or neither may be upstream or downstream of the other. In the embodiments of FIGS. 10-12, the turbines in the wind farm turbine array may be equipped with extremum seeking controllers. The extremum seeking controllers may determine the turbine operating parameters that maximize the combined power generated by the upstream turbine and downstream turbine(s). The operating parameters include blade pitch angle, rotor speed, torque, tip speed ratio, and other parameters.

FIGS. 10-12 are shown to include supervisory wake field controllers. A supervisory wake field controller may be configured to oversee all or a portion of all the turbines in a wind farm turbine array. A supervisory wake field controller may determine wind direction, use direction data to determine turbine hierarchy, use hierarchy to determine a cascade of self-optimizing controllers, and carry out other functions that may be advantageously performed by a central controller. For example, a supervisory wake field controller may be configured to implement all or a portion of process 700 (FIG. 7) and/or process 800 (FIG. 8). A supervisory wake field controller may be configured with all or a portion of the processing circuit of FIG. 6. In addition, a supervisory wake field controller may be equipped with other processing circuit elements designed to facilitate central oversight of the wind farm turbine array.

As described above, a supervisory wake field controller is not necessary for effective implementation of a power maximization strategy using self-optimizing controllers. Effective de-centralized turbine management may be realized when each self-optimizing controller in a wind farm turbine array is configured to maximize the combined power generated by the upstream turbine and the downstream turbine(s) (i.e., the turbines affected by the upstream turbine's wake). However, a supervisory wake field controller may be advantageously utilized according to exemplary embodiments, such as those represented in FIGS. 10-12.

Referring to FIG. 10, a block diagram of the power maximization logic using a supervisory wake field controller and self-optimizing controllers in a wind farm turbine array is shown, according to an exemplary embodiment. The direction of wind velocity may be from east to west. Turbines 1008, 1010 face the wind, i.e., their rotors are normal or approximately normal to the wind direction. Supervisory wake field controller 1002 may be configured to measure the direction of wind speed and determine the turbine hierarchy of wind farm turbine array. Because wind velocity is from the east, the east wind turbine 1010 is the upstream turbine, and the west wind turbine 1008 is the downstream turbine. West wind turbine 1008 experiences the wake effect of east wind turbine 1010. East wind turbine 1010 experiences no wake effects.

Based on the turbine hierarchy, supervisory wake field controller 1002 may be configured to determine which power outputs are combined for maximization by extremum seeking controllers 1004, 1006. Because east wind turbine 1010 is not in the wake of west wind turbine 1008, supervisory wake field controller 1002 may open logic switch 1012 of extremum seeking controller 1004, as shown in FIG. 10. As a result, extremum seeking controller 1004 does not consider the power generated Pₑₐₛₜ by east wind turbine 1010. Rather, extremum seeking controller 1004 may determine operating parameters (e.g., blade pitch angle and torque) of west wind turbine 1008 that maximize only power generated P_{west}. Because west wind turbine 1008 is in the wake of east wind turbine 1010, supervisory wake field controller 1002 may close logic switch 1014 of extremum seeking controller 1006, as shown in FIG. 10. As a result, extremum seeking controller 1006 considers both the power generated P_{west} by west wind turbine 1008 and Pₑₐₛₜ by east wind turbine 1010. Extremum seeking controller 1006 may determine operating parameters (e.g., blade pitch angle and torque) of east wind turbine 1010 that maximizes the combined power generated P_{west} and Pₑₐₛₜ.

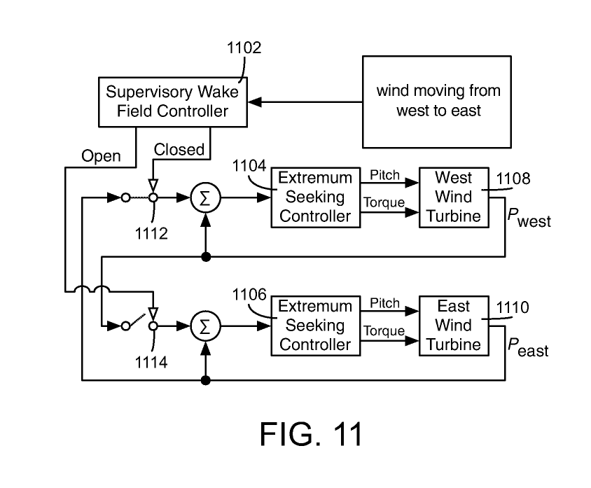

Referring to FIG. 11, a block diagram of the power maximization logic using a supervisory wake field controller and self-optimizing controllers in a wind farm turbine array is shown, according to an exemplary embodiment. The direction of wind velocity may be from west to east. Turbines 1108, 1110 face the wind, i.e., their rotors are normal or approximately normal to the wind direction. Supervisory wake field controller 1102 may measure the direction of wind speed and determine the turbine hierarchy. Because wind velocity is from the west, the west wind turbine 1108 is the upstream turbine, and the east wind turbine 1110 is the downstream turbine. East wind turbine 1110 experiences the wake effect of west wind turbine 1108. West wind turbine 1108 experiences no wake effects.

Based on the turbine hierarchy, supervisory wake field controller 1102 determines which power outputs are combined for maximization by extremum seeking controllers 1104, 1106. Because west wind turbine 1108 is not in the wake of east wind turbine 1110, supervisory wake field controller 1102 may open logic switch 1114 of extremum seeking controller 1106, as shown in FIG. 11. As a result, extremum seeking controller 1106 does not consider the power generated P_{west} by west wind turbine 1108. Rather, extremum seeking controller 1106 may determine operating parameters (e.g., blade pitch angle and torque) of east wind turbine 1008 that maximize only power generated Pₑₐₛₜ. Because east wind turbine 1110 is in the wake of west wind turbine 1108, supervisory wake field controller 1102 may close logic switch 1112 of extremum seeking controller 1104, as shown in FIG. 11. As a result, extremum seeking controller 1104 considers both the power generated P_{west} by west wind turbine 1108 and Pₑₐₛₜ by east wind turbine 1110. Extremum seeking controller 1104 may determine operating parameters (e.g., blade pitch angle and torque) of west wind turbine 1108 that maximizes the combined power generated P_{west} and Pₑₐₛₜ.

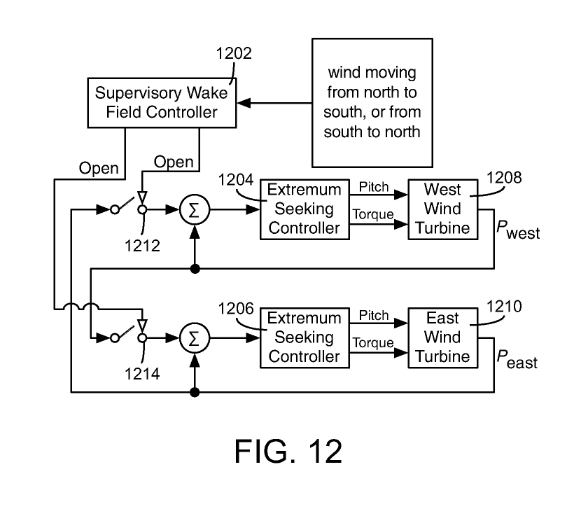

Referring to FIG. 12, a block diagram of the power maximization logic using a supervisory wake field controller and self-optimizing controllers in a wind farm turbine array is shown, according to an exemplary embodiment. The direction of wind velocity may be from north to south or from south to north. Turbines 1208, 1210 face the wind, i.e., their rotors are normal or approximately normal to the wind direction. Supervisory wake field controller 1202 may determine the quantities necessary to determine turbine hierarchy (including direction of wind speed, yaw angles of the individual turbines, etc.). Because wind velocity is from the north or from the south, neither west wind turbine 1208 nor east wind turbine 1210 is upstream or downstream of each other. Thus, both west wind turbine 1208 and east wind turbine 1210 experience no wake effects.

Based on the turbine hierarchy, supervisory wake field controller 1202 determines which power outputs are combined for maximization by extremum seeking controllers 1204, 1206. Because neither west wind turbine 1208 nor east wind turbine 1210 experience any wake effects, supervisory wake field controller 1202 may open logic switch 1212 of extremum seeking controller 1204 and logic switch 1214 of extremum seeking controller 1206, as shown in FIG. 12. As a result, extremum seeking controller 1204 does not consider the power generated Pₑₐₛₜ by east wind turbine 1210. Extremum seeking controller 1206, similarly, does not consider the power generated P_{west} by west wind turbine 1208. Extremum seeking controller 1204 may determine operating parameters (e.g., blade pitch angle and torque) of west wind turbine 1208 that maximizes only power generated P_{west}. Extremum seeking controller 1206, similarly, may determine operating parameters (e.g., blade pitch angle and torque) of east wind turbine 1210 that maximizes only power generated Pₑₐₛₜ. Extremum seeking controllers 1204, 1206 do not maximize the combined power generated because no wind turbine is downstream of the other. Thus, in the embodiment of FIG. 12, when wind velocity is in a north/south or south/north direction, P_{west} and Pₑₐₛₜ are maximized, even when P_{west} and Pₑₐₛₜ are considered in isolation.

According to an exemplary embodiment, the axial induction factor a can be used to maximize the power output of a turbine. For variable-pitch constant-speed turbines, the axial induction factor a is dependent upon the pitch. For variable-pitch variable-speed turbines, the axial induction factor a is dependent upon both the pitch angle of the blades and the rotation speed of the turbine. Thus, the axial induction factor may be optimized by a self-optimizing controller, similar to the optimization of power. In other words, axial induction factor a may be used as a proxy to maximize the power generated by one or more turbine in a wind farm turbine array. For example, the extremum seeking controllers represented in FIGS. 9-12 may optimize the axial induction factor of their respective turbines.

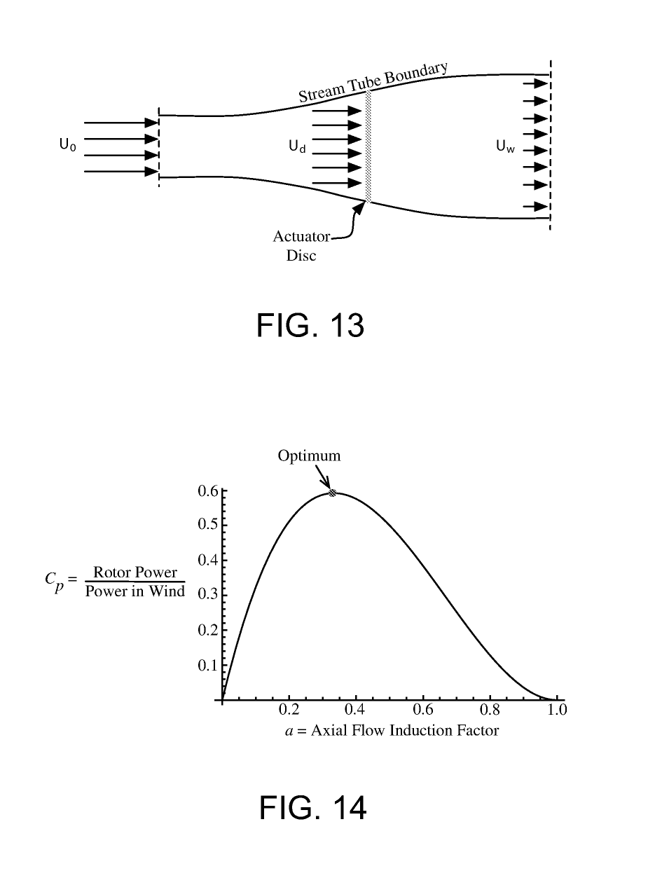

The following text describes how optimizing axial induction factor a in a cascading system of extremum seeking controllers may provide for optimized power delivery of a wind farm where wakes from upstream controllers affect power production of downstream controllers. In an exemplary embodiment, maximization of the power extracted from one or more turbines in a wind farm can be determined using an actuator disc model and a momentum theory based on Bernoulli's equation. Referring to FIG. 13, a schematic of the single actuator disc model and air stream tube is shown, according to an exemplary embodiment. The free stream velocity of the air upstream of the actuator disc (turbine) is U₀, the air velocity at the disc is U_{d}, and the air velocity far downstream of the disc is U_{w}. The air velocity at the disc U_{d} can be determined from the free stream air velocity U₀ and the axial induction factor (a) with

U_{d}=U₀(1−a) (1)

The air stream in the far wake is related to the free stream air velocity and the axial induction factor by

U_{w}=U₀(1−2a) (2)

Equation 2 may be valid for an axial induction factor (a) between 0 and ½. If a is greater than ½, then the wind velocity in the far wake would be negative.

The power coefficient Cₚ is the ratio of the power extracted by the wind turbine to the power available in the wind far upstream of the turbine:

$${C}_{p} = \frac{{P}_{t}}{{P}_{w}} \qquad ( 3 )$$

where Pₜ is the power generated by the wind turbine and P_{w} is the power in the wind far upstream of the turbine. The wind power P_{w} is determined from

P_{w}=½ρAU₀³ (4)

where A is the rotor area and ρ is the air density.

The power coefficient is related to the axial induction factor by

Cₚ=4a(1−a)² (5)

Referring to FIG. 14, a plot of the power coefficient as a function of the axial induction factor for a single actuator disk model is shown, according to an exemplary embodiment.

To determine the axial induction factor that maximizes the power output for a single turbine, the derivative of the power coefficient with respect to the axial induction factor is set to zero, and the axial induction factor is solved for. Taking the derivative of the power coefficient with respect to the axial induction factor gives

$$\frac{d {C}_{p}}{d a} = 4 {( 1 - a )}^{2} - 8 a ( 1 - a ) \qquad ( 6 )$$

Setting the derivative of the power coefficient with respect to the axial induction actor to zero and solving for the axial induction factor yields the following two solutions: a=⅓ and a=1. a=⅓ is the valid solution. The second derivative of the power coefficient with respect to the axial induction factor at a=⅓ is

$$\frac{{d}^{2} {C}_{p}}{d {a}^{2}} = - 16 ( 1 - a ) + 8 a = - 8 \qquad ( 7 )$$

Since the second derivative is negative, the maximum power coefficient is obtained when a=⅓. Setting a=⅓ in Equation 5 yields the maximum power coefficient of 16/27.

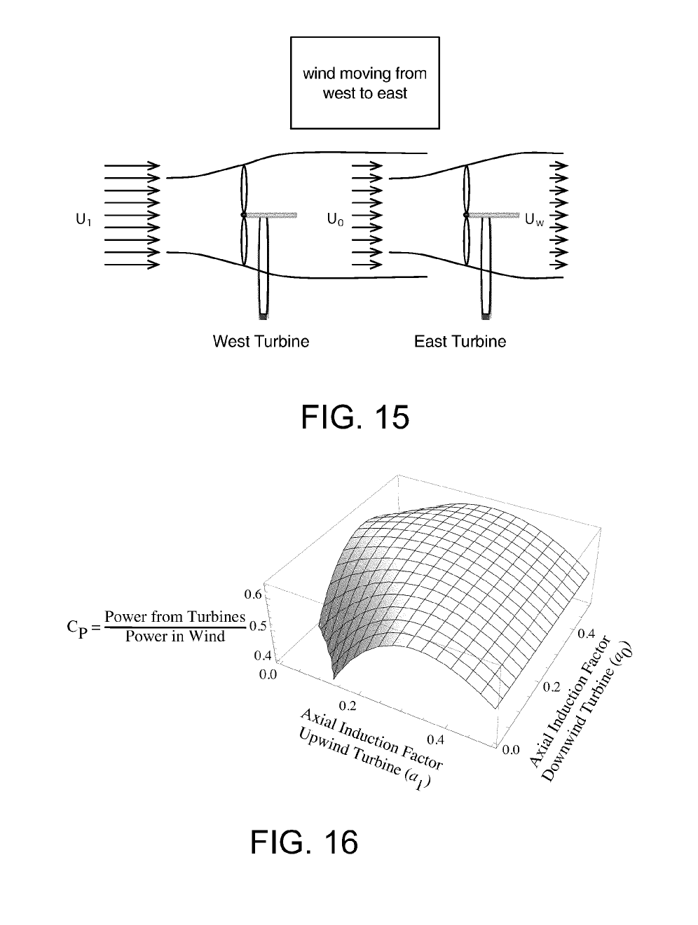

Referring to FIG. 15, an illustration of a wind farm with two turbines is shown, according to an exemplary embodiment. Wind is shown to be from the west. The east wind turbine is in the wake of the west turbine. The power coefficient for the wind farm with two turbines is

$${C}_{p} = \frac{{P}_{1} - {P}_{0}}{{P}_{w , 1}} \qquad ( 8 )$$

where P₁ is the power generated by the west turbine, P₀ is the power generated by the east turbine, and P_{w,1} is the power in the wind upstream of the wind farm and the west wind turbine. The numberss in the subscripts refer to the number of turbines in the wake of a turbine. For example, the west turbine has the east turbine in its wake and the subscript of “1” is used to refer to the west turbine. The east turbine has no turbines in its wake and a subscript of “0” is used to refer to the east turbine.

The power coefficient Cₚ for the two turbine system of FIG. 15 can be calculated. Solving Equation 3 for the wind turbine power and substituting Equation 8 gives

$${C}_{p} = \frac{{C}_{p , 1} {P}_{w , 1} + {C}_{p , 0} {P}_{w , 0}}{{P}_{w , 1}} = {C}_{p , 1} + {C}_{p , 0} \frac{{P}_{w , 0}}{{P}_{W , 1}} \qquad ( 9 )$$

From Equation 4 the power in the upstream of the west turbine is

P_{w,1}=½ρAU₁³ (10)

and power in the wind upstream of the east turbine is

P_{W,0}=½ρAU₀³ (11)

Equation 2 can be used to determine the wind speed upstream of the east turbine U₀ from the wind speed upstream of the west turbine U₁ and the axial induction factor a₁ from the west turbine:

U₀=U₁(1−2a₁) (12)

Substituting Equations 10 and 12 into 11 gives

P_{w,0}=(1−2a₁)³P_{w,1} (13)

Substituting Equation 13 into Equation 9 gives

Cₚ=C_{p,1}+C_{p,0}(1−2a₁)³ (14)

and substituting Equation 5 into Equation 14 yield the power coefficient

Cₚ=4a₁(1−a₁)²+4a₀(1−a₀)²(1−2a₁)³ (15)

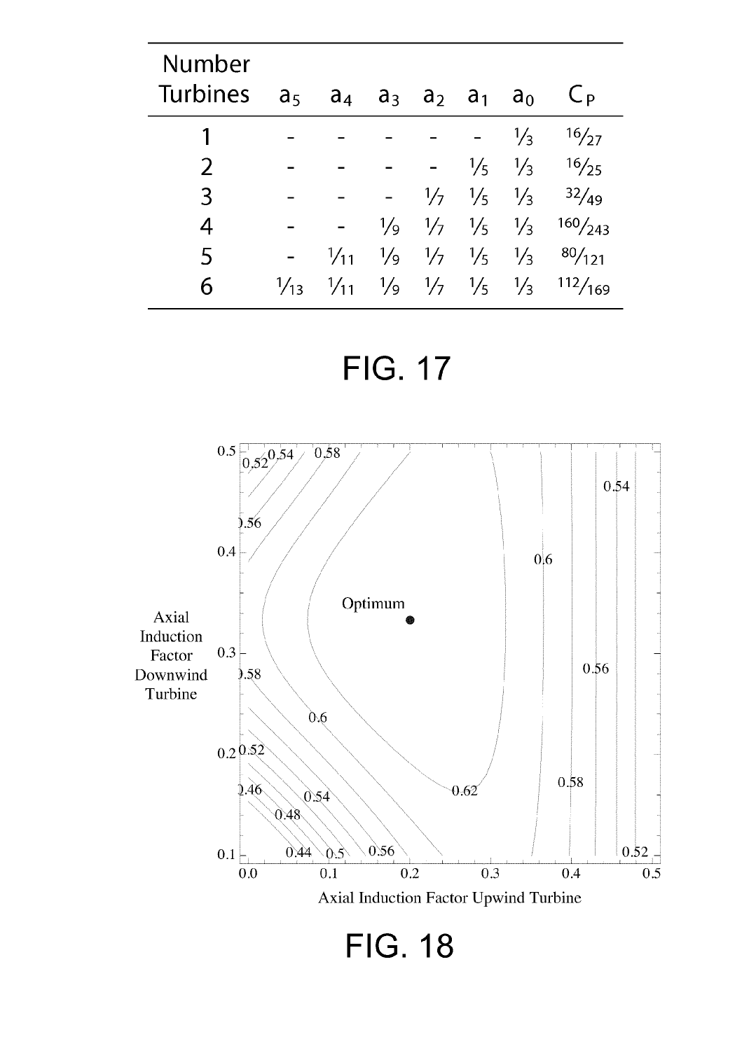

Referring to FIG. 16, a plot of the power coefficient for the two turbine wind farm (Cₚ) versus the axial induction factors for the upwind and downwind turbines is shown, according to an exemplary embodiment. Referring to FIG. 18, a contour plot of the power coefficient versus the axial induction factors for the two turbine wind farm is shown, according to an exemplary embodiment. The maximum power coefficient is 16/25 at axial induction factors of ⅕ for the upwind turbine and ⅓ for the downwind turbine.

Referring to FIG. 17, a table of axial induction factors that maximize power output and of the respective maximum power coefficients (Cₚ) is shown, according to an exemplary embodiment. The procedure for calculating the power coefficient described above may be used to determine the axial induction factors that maximize the power output for three to six turbines in the wake of other turbines. Extremum seeking controllers of a wind farm may use a table such as that shown in FIG. 17 to ‘seek’ the identified axial induction factors (e.g., by adjusting the pitch angle of the blades and/or the torque or rotation speed of the turbine).

The construction and arrangement of the systems and methods as shown in the various exemplary embodiments are illustrative only. Although only a few embodiments have been described in detail in this application, many modifications are possible. For example, the position of elements may be varied and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present application.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for controlling turbines in a wind farm turbine array, the method comprising:
using a cascade of self-optimizing controllers to in an attempt to maximize the power generated by at least a portion of the wind farm turbine array, wherein at least one of the self-optimizing controllers for an upstream turbine is configured to control the upstream turbine in an attempt to maximize the combined total of (a) the power output of the upstream turbine and (b) the power output of at least one downstream turbine.

2. The method of claim 1, wherein self-optimizing controllers are extremum seeking controllers.

3. The method of claim 2, wherein the self-optimizing controller for the upstream turbine adjusts a pitch angle and a rotor speed of the upstream turbine in the attempt to maximize the combined power output of the upstream and downstream turbines.

4. The method of claim 1, further comprising:
determining a change in wind direction;
controlling at least one turbine of the wind farm turbine array to a position that is normal to the wind direction; and
using the wind direction, the turbine position, or the wind direction and the turbine position to identify any downstream turbines from the at least one turbine.

5. The method of claim 1, further comprising:
maintaining a hierarchy of turbines for the wind farm turbine array based on which turbines are upstream or downstream from each other; and
using the hierarchy of turbines to determine the order of cascading for the self-optimizing controllers.

6. The method of claim 1, wherein the turbines are variable-pitch, variable-speed turbines.

7. The method of claim 2, wherein the extremum-seeking control strategy compensates for integral windup.

8. The method of claim 1, wherein the self-optimizing controllers maximize the power generated by the wind farm without using a turbine wake model.

9. A control system for use with a wind farm turbine array, comprising:
a plurality of self-optimizing controllers, at least one self-optimizing controller for each turbine of the wind farm turbine array, wherein at least one of the self-optimizing controllers is configured to seek an operating parameter that maximize the combined power generated by the controller's turbine and at least one turbine downstream from the controller's turbine.

10. The system of claim 9, wherein the at least one of the self-optimizing controllers is an extremum seeking controller.

11. The system of claim 9, wherein the operating parameter comprises a pitch angle or a rotor speed for the upstream turbine.

12. The system of claim 9, further comprising:
a hierarchy analyzer configured to generate hierarchy data, wherein the hierarchy data indicates which turbines are downstream from other turbines.

13. The system of claim 12, wherein hierarchy analyzer determines which turbines are downstream based on wind direction, a turbine position, or wind direction and turbine position.

14. The system of claim 9, further comprising:
an array optimizer configured to provide the self-optimizing controllers with upstream/downstream cascade data using the hierarchy data.

15. The system of claim 9, wherein the self-optimizing controller that seeks to maximize the combined power generated by the controller's turbine and the at least one downstream turbine comprises:
an interface configured to receive power generation data from the downstream turbine.

16. The system of claim 10, wherein the extremum-seeking control strategy compensates for integral windup.

17. Non-transitory computer-readable media with computer-executable instructions embodied thereon that when executed by a computing system perform a method for improving power generation by a wind farm, the media comprising:
instructions for providing self-optimizing control of an upstream turbine that optimizes the power output of the upstream turbine based on the combined power output of the upstream turbine and on the power output of at least one downstream turbine.

18. The computer-readable media of claim 17, wherein the instructions implement an extremum-seeking control strategy configured to seek a turbine operating parameter that maximizes the combined power output of the upstream turbine and the downstream turbine.

19. The computer-readable media of claim 17, further comprising instructions for identifying the downstream turbine as being downstream from the upstream turbine.
